(19) United States
(12) Patent Application Publication
(10) Pub. No.: US 2019/0008142 A1
(43) Pub. Date: Jan. 10, 2019

(54) AUTOMATIC DEVICES CONFIGURED TO PERFORM A CRYOPROCEDURE ON AT LEAST ONE BIOLOGICAL SAMPLE CARRIED BY ONE OR MORE CARRIERS

(71) Applicant: FertileSafe Ltd., Nes Tziona (IL)

(72) Inventor: Amir Arav, Nes Tziona (IL)

(73) Assignee: FertileSafe Ltd., Nes Tziona (IL)

(21) Appl. No.: 16/067,587

(22) PCT Filed: Jan. 13, 2017
(86) PCT No.: PCT/IL2017/050044

§ 371 Date: Jun. 29, 2018

Related U.S. Application Data
(60) Provisional application No. 62/278,056, filed on Jan. 13, 2016.
(60) Provisional application No. 62/240,646, filed on Oct. 13, 2015.
(60) Provisional application No. 62/358,045, filed on Jul. 3, 2016.

(30) Foreign Application Priority Data
Jan. 13, 2016 (IL) PCT/IL2016/051115

(51) Int. Cl. A01N 1/02

(52) U.S. Cl. CPC A01N 1/0268; A01N 1/0252

(57) ABSTRACT

Automatic devices configured to perform a cryoprocedure on at least one biological sample carried by one or more carriers. The device includes a carrier holder, a container holder, a carrier driver and a container driver. The carrier holder holds the one or more carriers in an upright orientation while holding the at least one biological sample. The container holder holds two or more containers each in a predetermined location on the container holder. The carrier driver translates the carrier holder and the container driver translates the predetermined locations so as to position one of them in a position accessible to the carrier holder, so as to enable the carrier driver to submerge an active portion of each one or more carriers held by the carrier holder in a predetermined vertical depth in the position accessible to the carrier holder.

### BACKGROUND OF THE INVENTION

This application is a 371 of PCT/IL2017/050044, filed Jan. 13, 2017, which claims benefit of provisional application Ser. No. 62/278,056, filed Jan. 13, 2016 and claims benefit of PCT/IL2016/051115, filed Oct. 13, 2016, which claims benefit of provisional application Ser. No. 62/240,646, filed Oct. 13, 2015 and claims benefit of provisional application Ser. No. 62/358,045, filed Jul. 3, 2016. The entire contents of each of these applications are incorporated herein by reference.

### TECHNICAL FIELD

This application generally relates to cryopreservation, and more specifically to automatic devices for performing vitrification, culturing and/or cryopreservation of biological samples.

### BACKGROUND

Preservation of biological samples, for example oocytes and embryos at very low temperature is known as cryopreservation. One of the major challenges of cryopreservation is to prevent the intracellular liquid within the sample from turning into ice crystals.

Two common techniques of cryopreservation are slow freezing and vitrification. During the slow freezing process ice crystals are formed intercellularly, and as a result the remaining liquid becomes hypertonic thus allowing intracellular water to leave the cells and to pass towards an outside of the cells by exosmosis, thus preventing intracellular crystallization.

In vitrification, intercellular and intracellular water crystallization is avoided by means of a very high cooling rate. According to some vitrification protocols, the sample is plunged into a very cold cryogenic medium, e.g., liquid nitrogen (LN) or LN slush, thus resulting in very high cooling rates, which enables vitrification rather than crystallization of the intracellular and intercellular liquids.

In some protocols, vitrification may be further enabled by increasing the viscosity of the sample, for example by applying various cryoprotectants and/or other applicable additives, by reducing the volume of the sample, or by a combination thereof. For example, the publication “Vitrification of oocytes and embryos” (Amir Arav, “Embryonic development and manipulation in animal development”, edited by A. Lauria and F. Gandolfi, Portland Press, London, U.K., 1992), presents a method of vitrifying cells enclosed in small drops sufficient to keep them in physiological conditions. In this publication, Arav reports that with volume of 70 nanoliter drops, good survival rates can be achieved even with low concentration of cryoprotectant.

Vitrification is further described, e.g., in the following publications: “Titration of Vitrification Solution in Mouse Embryo Cryopreservation” (A. ARAV, L. GIANAROLI, AND P. SURIANO, Cryobiology 25(6), 1988) presents reducing the toxicity of the vitrification solution by decreasing the time and temperature of embryo exposure to cryoprotectant solution.

“Osmotic and cytotoxic study of vitrification of immature bovine oocytes” (A. Arav, D. Shehu, and M. Mattioli, Journal of Reproduction and Fertility, 99: 353-358, 1993) presents experiments conducted in order to determine the composition of a solution suitable for vitrification of immature bovine oocytes.

“New trends in gamete's cryopreservation” (Amir Arav, Saar Yavin, Yoel Zeron, Dity Natan, Izik Dekel, and Haim Gacitua. Molecular and Cellular Endocrinology, 187: 77-81, 2002) presents techniques to improve freezing and vitrification of sperm, oocytes and embryos, based on ‘Multi-Thermal-Gradient’ (MTG) freezing.

“Measurement of essential physical properties of vitrification solutions” (S. Yavin and A. Aray. Theriogenology, 67(1): 81-9, 2007) examines the principal parameters associated with successful vitrification, and composes guidelines to aspects of the vitrification process.

“Embryo cryopreservation in the presence of low concentration of vitrification solution with sealed pulled straws in liquid nitrogen slush” (Saar Yavin, Adaya Aroyo, Zvi Roth, and Amir Aray. Human Reproduction, 24(4): 797-804, 2009) presents a vitrification method that combines LN slush and sealed pulled straws (SPS).

Basically, most of the vitrification protocols in use today are manual: they involve preparation of the sample, e.g., in a petri plate or petri plates, thereafter transferring the pre-prepared sample to a cryopreservation device. For example, WO/1999/011121, Gabor explains that in the cattle breeding sector it has been known for several years that it is possible to preserve egg cells or embryos by introducing them into an end of a narrow tube or ‘straw’, which is thereafter subjected to cryogene cooling. For some species such as pigs this preservation, however, has failed to work in practice. Hence Gabor prescribes the use of still narrower tube ends which can easily, by capillary action, be loaded with a small amount (1-2 $g(m)1) of a holding liquid for the item to be cooled, and which, when dipped into the cryogene cooling medium, provides for a close cooling contact with this medium, partly through an open end connection and partly through an outer pipe end wall of a very small thickness. A high preservation quality is achieved by the associated extremely fast cooling. Preferably, the thin tube ends are provided by a pulling out of the middle portion of a thermoplastic ‘mini straw’, and then cutting the straw at the middle of the resulting narrowed straw length, thus leaving the opposed thicker pipe ends as convenient handle portions.

U.S. Patent Application 2011/0207112 (Burbank and Jones, published in 2011) discloses an automated system and method of cryopreservation and reanimation of oocytes, embryos, or blastocysts. One or more oocytes or embryos are positioned in a processing container, the processing container being configured to allow fluid to flow into and out of the processing container, where two or more fluids flow into and out of the processing container with oocytes or embryos therein. US Patent Application 2016/0029619 (Yu Sun and Jun LIU, published in 2016) discloses a system and methods for automated vitrification of mammalian oocytes or embryos. The system and methods enable automated processing of oocytes or embryos in vitrification solutions; robotically moving vitrification devices that carry processed cells for freezing in liquid nitrogen; automated sealing of the frozen devices; and transferring the sealed devices to an automated storage system for long-term cryopreservation.

### SUMMARY OF THE INVENTION

According to some embodiments of the invention, there is provided an automatic device configured to perform a cryoprocedure on at least one biological sample carried by one or more carriers, the device comprising:
a carrier holder configured to receive and hold the one or more carriers in an upright orientation while holding the at least one biological sample;
a container holder configured to hold two or more containers each in a predetermined location on the container holder;
a container driver coupled to the container holder, the container driver is configured to translate the predetermined locations so as to position one of them in a position accessible to the carrier holder so as to submerge an active portion of the carrier held by the carrier holder in a predetermined vertical depth in the position accessible to the carrier holder.

According to some embodiments of the invention, there is provided an automatic device configured to perform a cryoprocedure on at least one biological sample carried by one or more carriers, the device comprising:
a carrier holder configured to receive and hold the one or more carriers in an upright orientation while holding the at least one biological sample;
a carrier driver configured to translate the carrier holder;
a container holder configured to hold two or more containers, each in a respective predetermined location;
wherein the carrier driver is configured to translate the one or more carriers so as to bring the one or more carriers to the at least one of the two or more predetermined locations so as to submerge an active portion of each one or more carriers in a predetermined vertical depth in the at least one of the two or more predetermined locations.

According to some embodiments of the invention, there is provided an automatic device configured to perform a cryoprocedure on at least one biological sample carried by one or more carriers, the device comprising:
a carrier holder configured to receive and hold the one or more carriers in an upright orientation while holding the at least one biological sample;
a container holder configured to hold two or more containers each in a predetermined location on the container holder;
a carrier driver configured to translate the carrier holder;
a container driver coupled to the container holder, the container driver is configured to translate the predetermined locations so as to position one of them in a position accessible to the carrier holder so as to enable the carrier driver to submerge an active portion of each one or more carriers held by the carrier holder in a predetermined vertical depth in the position accessible to the carrier holder.

Some embodiments provide an automatic device wherein each one of the one or more carriers is a straw.

Some embodiments provide an automatic device wherein the container holder is a rotating plate.

Some embodiments provide an automatic device, wherein the carrier holder is configured to hold the one or more carriers in an upright position.

Some embodiments provide an automatic device, wherein the container holder is made of metal.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic presentation of a capillary device configured to apply cryoprocedures to a biological sample;

FIG. 2A illustrates a pod, according to embodiments of the invention;

FIG. 2B illustrates a cut of FIG. 2A, according to embodiments of the invention;

FIG. 2C illustrates a pod comprising a circumferential wall with a polygonal cross section, according to embodiments of the invention;

FIG. 2D schematically illustrates a biological sample in a longitudinal cut of an orifice, in embodiments of the invention;

FIG. 2E schematically illustrates an alternative pod, according to embodiments of the invention;

FIG. 2F is an image of a perforated element, according to embodiments of the invention; and

FIGS. 3A, 3B and 3C illustrate coupling of pod 200 with capillary duct 108, according to embodiments of the invention;

FIG. 4 is a flowchart illustrating procedures taken in order to prepare a sample for vitrification, according to embodiments of the invention;

FIG. 5 illustrates a straw having four different layers of liquid therein, according to embodiments of the invention;

FIG. 6 is a flowchart illustrating procedures taken in order to prepare a sample for vitrification, according to embodiments of the invention; and

FIGS. 7A, 7B and 7C illustrate stages of loading the straw of FIG. 5, according to embodiments of the invention;

FIGS. 8A, 8B, 8C and 8D illustrate loading four solutions into a straw, according to embodiments of the invention;

FIG. 9 schematically illustrates a system for automatic vitrification of one or more biological samples, according to embodiments of the invention;

FIG. 10 illustrates a device for automatic vitrification of one or more biological samples, according to embodiments of the invention;

FIG. 11 illustrates in detail elements of the device enabling relative motion, according to embodiments of the invention;

FIGS. 12A and 12B schematically illustrate a straw in a diagonal position, according to embodiments of the invention;

FIG. 13 illustrates operation of the device of FIGS. 10 and 11, according to some embodiments of the invention;

FIG. 14 illustrates the device of FIGS. 10 and 11 with a closed liquid nitrogen container, according to some embodiments of the invention;

FIG. 15 illustrates a liquid nitrogen container, with a closed lid, according to embodiments of the invention;

FIG. 16 illustrates the liquid nitrogen container of FIG. 15, with an open lid, according to embodiments of the invention; and

FIG. 17 illustrates a device for automatic vitrification of one or more biological samples, according to embodiments of the invention.

### DETAILED DESCRIPTION

In the following description components that are common to more than one figure may be referenced by the same reference numerals.

In addition, unless specifically noted otherwise, embodiments described or referenced in the present description can be additional and/or alternative to any other embodiment described or referenced therein.

Herein there are disclosed embodiments of the invention that are configured to vitrify at least one biological sample, i.e., either a single sample or multiple samples. However, due to simplicity considerations and in order to make the description more readable, the description refers to “a sample”. It should be understood, that unless specifically noted otherwise, whenever “a sample” is mentioned, the same should apply also to “at least one sample”. Similarly, whenever reference is made to “the sample”, the same should apply to “the at least one sample” as well.

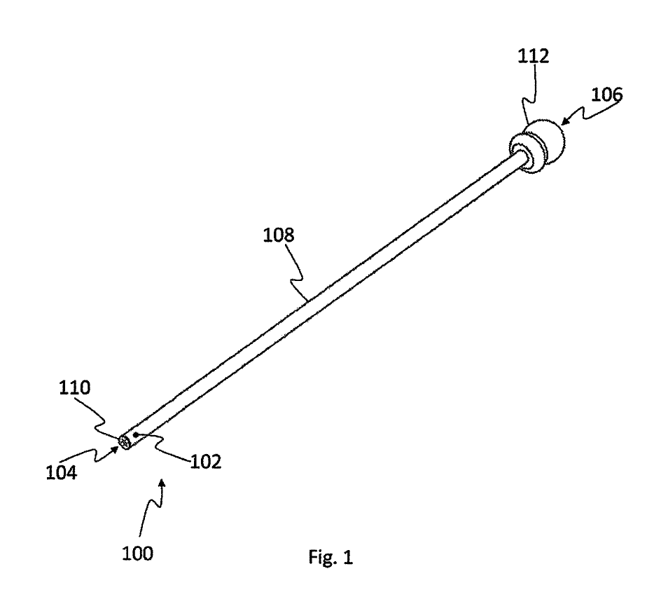

FIG. 1 is a schematic presentation of a capillary device 100 configured to apply cryoprocedures to a biological sample 102. Capillary device 100 may comprise transparent, translucent and/or opaque members. Accordingly, biological sample 102 that resides inside the capillary device may be unseen from the outside, though in the figure, in order to explain the invention, the biological sample appears as if the device is transparent.

The presently illustrated device has a capillary duct 108 with two ends. In order to distinguish between the ends they are designated as a distal end 104 and a proximal end 106. In the distal end the device comprises a perforated element 110. In the proximal end the device is illustrated when coupled to a manual pump 112. It is noted that the existence of manual pump 112 is non-mandatory and in some embodiments it is missing. Moreover, while the pump in the figure is a manual pump, this is non-mandatory as well and in other embodiments another pump may be used, such as an electrical pump, or even a different kind of a manual pump. Inside the capillary device there is a free space 114, constituting “capillary space”. Similar to the capillary duct, the capillary space also has a distal end (at the capillary duct's distal end) and a proximal end (at the capillary duct's proximal end).

A cryoprocedure, with reference to some embodiments described herein, comprise, e.g., culturing or vitrification or cryopreservation or thawing or warming or a stage of culturing or a stage of vitrification or a stage of cryopreservation or a stage of thawing or a stage of warming, etc. In some embodiments a cryoprocedure may be any one of culturing, vitrification, freezing, lyophilization, cryopreservation, thawing and/or warming. In some embodiments cryoprocedures may comprise vitrification and cryopreservation, with or without culturing. In some embodiments cryoprocedures may comprise cryopreservation and thawing or cryopreservation and warming. In some embodiments cryoprocedures may comprise vitrification, cryopreservation and thawing or vitrification, cryopreservation and warming. In some embodiments, though, cryoprocedures may comprise culturing, vitrification, cryopreservation and thawing or culturing, vitrification, cryopreservation and warming. Herein, the description refers to vitrification as an example. However, it should be appreciated that unless specifically noted, other cryoprocedures can be referred to hereinafter, wherein a cryoprocedure can be, e.g., any one of the cryoprocedures mentioned above.

The biological sample 102, shortly referred to as “sample”, may be of an animal origin, including but not restricted to human beings, mammals, and vertebrates. In some cases, the biological sample may be a single cell sample, such as an oocyte or sperms, while in other cases, the biological sample may be a multi-cell suspension. In yet other cases, the biological sample may be a tissue, for example a piece of tissue, such as a slice of ovarian tissue or a slice of testicular tissue, an embryo, or others. In some cases, the invention is used for handling reproductive biological samples (such as oocytes and/or sperm and/or embryos and/or ovarian tissues and/or testicular tissue etc.). However, the invention is not limited to reproductive biological samples and embodiments thereof may be directed to other kinds of biological samples. One non limiting example for using the invention with other (non-reproductive) kinds of biological samples is preparing a piece of tissue taken in a biopsy for cryopreservation, e.g., before the piece can be sent for analysis.

According to embodiments of the invention, the biological sample can be loaded into the capillary space of the capillary duct using different methods. It is well known that capillarity (known also as capillary action or capillary motion) gives rise to the ability of a liquid to flow in narrow spaces without the assistance of, or even in opposition to, external forces such as gravity. Accordingly, the mass of the biological sample affects the ability to load it into the capillary duct by capillary action. For small biological samples the loading of the cells may take place via capillary action. For larger biological samples, loading may take place using a pump such as pump 112 in order to pump-in the sample. In some embodiments, an applicator can be used in order to insert the sample into the capillary space, etc. If applicable to the case, a pump can be used also for loading small biological samples. It is known per se that the determination of a sample being small or large so as to allow or prevent its capillary loading is effected, e.g., by the radius of the capillary space, the mass of the liquid and the mass of the sample.

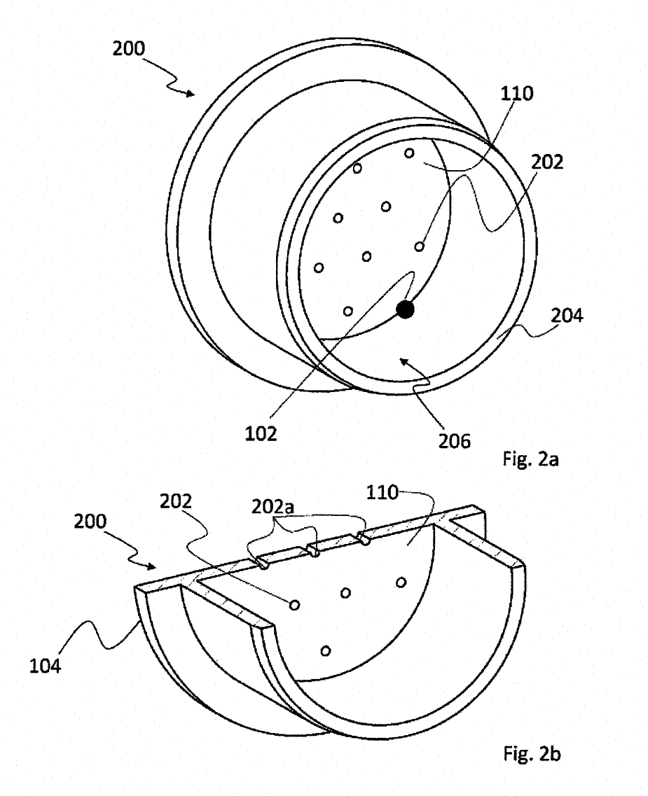

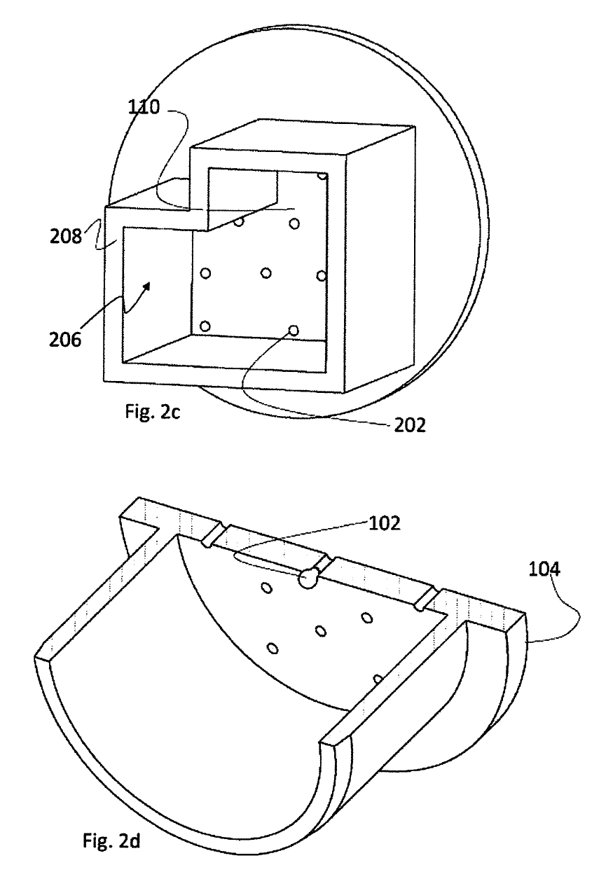

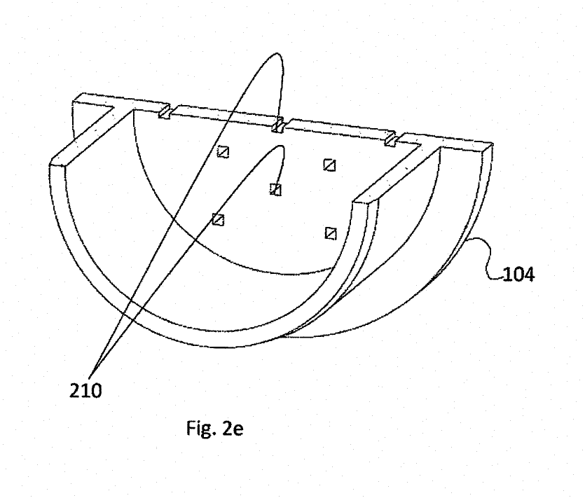

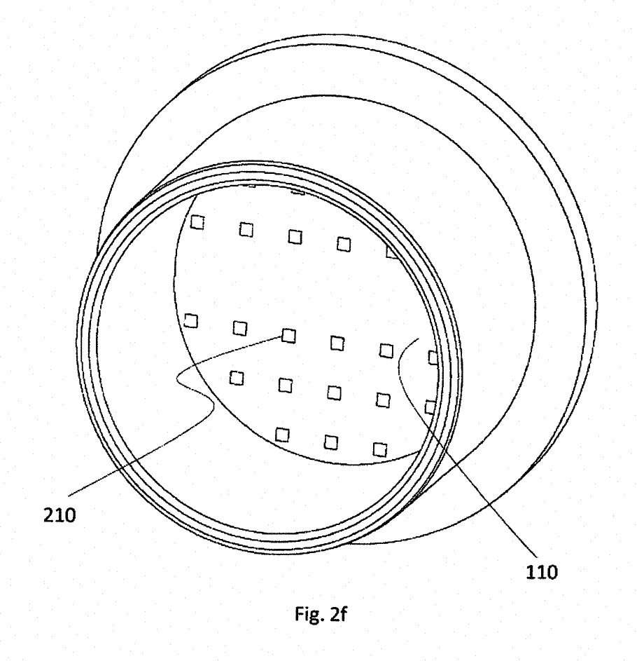

FIG. 2A and FIG. 2B present a device referred to as a pod 200, according to embodiments of the invention. While in FIG. 2A the whole pod is presented, FIG. 2B presents a cut in pod 200, illustrated in order to demonstrate features of the embodiments. Pod 200 comprises a perforated element 110. The perforated element comprises at least one orifice 202 whose diameter is small enough to prevent the biological sample from flowing therethrough, i.e., at least one orifice whose diameter is smaller than the diameter of the biological sample. It should be understood that a biological sample flowing through an orifice actually outflows from the pod, and in most cases this means that the sample is lost. On the other hand, samples (and other particles) whose diameter is larger than the diameter of an orifice cannot pass therethrough. Therefore, a perforated element is applicable for restricting passage of large particles, including biological samples and/or other particles, through the perforated element, wherein “a large particle” is a particle whose diameter is larger than the diameter of the largest orifice. If applicable, the perforated element can be designed so as to partially restrict passage of large elements, by designing the perforated element to comprise orifices of varying diameters, while only part of the orifices have diameters smaller than the diameter of the partially restricted particles and other orifices have diameters that are larger.

The order of magnitude of the orifices' diameters, according to embodiment of the invention is measured in micrometers (μm) unlike Angstroms, and therefore, a solution in which the distal end is submerged can still pass through the perforated element.

Accordingly, in some embodiments, the diameter of an orifice 202 should not exceed 5 μm (micrometer) or 10 μm or 15 μm or 20 μm or 25 μm or 40 μm or 50 μm or 55 μm or 60 μm or 65 μm or 70 μm or 75 μm or 80 μm or 85 μm or 90 μm or 95 μm or 100 μm or 120 μm or 140 μm or 150 μm or 160 μm or 180 μm or 200 μm or 250 μm or 300 μm or 350 μm or 400 μm or 450 μm or 500 μm or another diameter configured to be smaller than the diameter of the biological sample.

It is noted that “at least one orifice” covers the case wherein the perforated member comprises a single orifice, as well as those cases when the perforated member comprises multiple orifices.

Pod 200 comprises a circumferential wall 204, delineating a holding space 206 in the pod, in which a biological sample 102 may reside. The illustrated embodiments of pod 200 have a circular cross section and circumferential wall 204 also has a circular cross section. However, this is not limiting and circumferential wall may have a different shape such as a polygonal cross section of circumferential wall 208, as illustrated in FIG. 2C. Circumferential wall 208 could have been drawn as a rectangular circumferential wall, square circumferential wall, pentagonal circumferential wall or any other basic/classic cross section of circumferential wall in order to illustrate that the cross section of the pod's circumferential wall may be of any shape applicable to the case. There may exist pods comprising any one of the aforementioned cross sections and others, if applicable.

A cut in perforated element 110 is illustrated in FIG. 2B, wherein the cut exposes longitudinal cuts 202a in three orifices 202. The longitudinal cuts illustrate that orifices 202 actually cross perforated element 110, thereby allowing passage across the perforated member to particles whose diameter is smaller than the diameter of the perforations.

Furthermore, FIGS. 2A, 2B and 2C illustrate orifices 202 with circular cross section. This is non-mandatory as well and other forms of orifices may be used if applicable. For example, it should be appreciated that under certain conditions, such as negative pressure, biological samples 102, such as oocytes, may be pulled, inside holding space 206, towards perforated elements 202. Under such conditions the biological sample may tend to penetrate the orifices, e.g., as illustrated in FIG. 2D. One object of the invention is to improve sample recovery rates further to thawing or warming the sample after cryopreservation, while such penetration of the sample into an orifice deteriorates its survival and recovery rates. Therefore, according to alternative embodiments, such as the alternative pods of FIG. 2E, orifices having a square cross section are used, thus reducing the tendency of the biological sample to penetrate into the orifice.

FIG. 2F is an image of a perforated element, according to embodiments of the invention, wherein a perforated element 110 with square orifices 210 can be seen.

Prior to advancing with the description it should be considered that the forms of orifices described thus far (round and square) are non-limiting and other orifices, having different forms and shapes may exist. For example, an orifice may be a slit through which capillary flow may appear.

Further to being introduced to several pods, it should be appreciated that generally, a pod comprises a vessel and a holding space. The vessel, according to some embodiments, comprises the circumferential wall and the perforated element. The vessel comprises at least one opening at its proximal end and a plurality of orifices on its distal end.

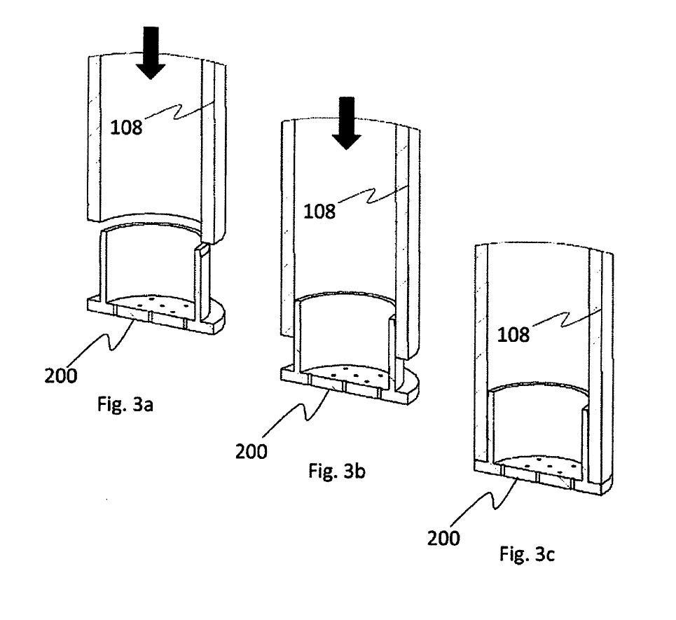

A pod can be coupled to a capillary duct, such as duct 108 of FIG. 1. The capillary duct and the pod are structurally couplable. For example, FIGS. 3A to 3C illustrate coupling of pod 200 with capillary duct 108, according to embodiments of the invention. An open distal end of the capillary duct approaches the circumferential wall 204 of pod 200. In order to couple the pod with the capillary duct, the external form of circumferential wall 204 should adapt to the internal form of the capillary duct at and close to the duct's distal opening, similar to the adaptation of a key to a keyhole. In FIG. 3B the capillary duct further approaches the circumferential wall and in FIG. 3C coupling is achieved when the pod locks the capillary duct and/or vice versa (i.e., the capillary duct locks the pod). Further to the coupling, the holding space of the pod and the capillary space of the capillary duct may form together a preparation space in which a liquid column may be formed. Moreover, in some embodiments the pod can be manufactured with the capillary duct, as a single unit, wherein the sample may be loaded into the preparation space, e.g., from the proximal end of the capillary duct/space.

Further to explaining how a preparation space is formed, it is noted that alternative ways may exist, according to the invention. For example, instead of coupling the capillary duct to the pod by pressure, they can be coupled, e.g., by screwing. According to another alternative, they can be coupled by pressure while the capillary duct fits into the pod, instead of fitting the pod into the capillary duct, as illustrated, e.g., in FIGS. 3A to 3C. Any other alternative applicable to the case may be used here, as long as the result is a preparation space obtained by coupling a pod with a perforated element to a capillary duct.

In those cases wherein the pod fits into the capillary duct or the capillary duct fits into the pod, it should be appreciated that there is an element that has hugged element. When the pod fits into the capillary duct, it is the duct that hugs the pod while the pod is being hugged by the duct. When the capillary duct fits into the pod, the pod is the hugging element while the duct is the hugged element. It is known that in low temperature different materials display different degrees of shrinkage. Therefore, in order to prevent disintegration of the duct-pod connection in low temperature, the hugging element needs to be made of material with higher shrinking coefficient compared to the hugged element. For example, if the capillary duct is the hugging element which is manufactured of poly propylene, the pod can be made of poly carbonate.

Further to being introduced to some devices according to the invention, attention is drawn now to methods for using the device for cryopreservation of a biological sample. It should be appreciated that due to capillarity, when the distal end of the capillary duct (such as 104 in FIG. 1) is immersed in a liquid, the capillary space will draw the liquid up, giving rise to a liquid column. Herein the term “immersing” means bringing the distal end in touch with a liquid, so as to allow capillary action to build a liquid column in the capillary duct. On the other hand, it is also possible to drain liquids from within the capillary space of the capillary duct. Draining can be done, e.g., by bringing the distal end in touch with a material having adhesion which is strong enough to overcome the adhesion forces operating in the capillary space to hold the liquid column. For example, it is possible to drain the liquid with a blotting paper or even with an absorbent cottonwool or cotton. Alternatively, instead of draining the capillary duct with an absorbent material, it is possible to push the liquid out of the capillary duct by using, for example, a pump coupled to the duct's proximal end.

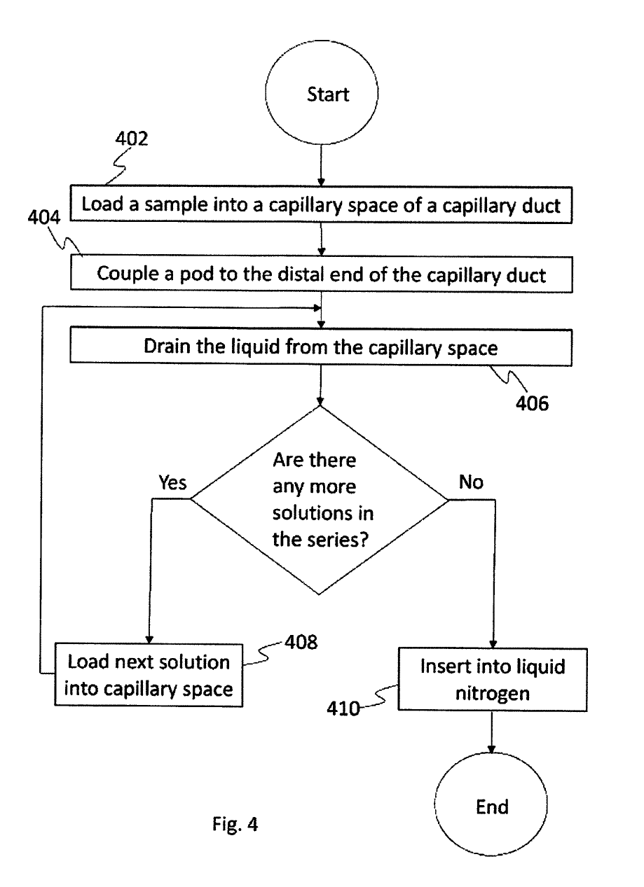

It has been explained above that the biological sample can be loaded into the capillary duct, for example, by capillary action. In addition, it is known in the art that the process of vitrification involves changes of solutions in which the sample should be submerged. Having said all that, FIG. 4 presents a flowchart illustrating procedures taken in order to prepare a sample for vitrification, according to embodiments of the invention.

In 402 a sample is loaded to a capillary space (e.g., 114) of a capillary duct (e.g. 108). As was previously explained, loading can be done, for example, by capillary action or by using a pump. It should be noted that immediately further to loading, the sample resides inside the capillary space, submerged in a liquid that is similar to the liquid in which it was submerged prior to loading. Hence, for example, had the sample been stored in a holding medium prior to loading, then immediately after loading there would be a sample submerged in the holding medium inside the capillary space.

In 404 a pod is coupled to the distal end of the capillary duct. Coupling is performed by any way applicable to the case, such as by applying pressure (see FIGS. 3A to 3C), by screwing etc. The perforated member of the pod would prevent the sample from unintentionally running out of the capillary space via the distal end of the capillary duct.

It should be appreciated by those versed in the art of vitrification that in order to prepare a biological sample for vitrification the sample needs to be submerged in a series of solutions that gradually replace the water that naturally reside in the sample with cryoprotectants. In the example of vitrification these are known per se holding medium (HM), equilibration solutions (ES) and vitrification solution (VS). Holding medium can be buffer solution supplement with proteins, equilibration solution could be, e.g., 7.5 VN Dimethyl sulfoxide (DMSO), 7.5%VN Ethylene glycol (EG) and 20% fetal calf serum (FCS) in buffer solution. Vitrification solution can be 15%VN DMSO, 15%VN EG, 0.5M sucrose and 20% fetal calf serum (FCS) in buffer solution. Accordingly, for each solution in the series, in 406 the liquid within the capillary space is drained, e.g. by touching with the distal end on a blotting paper, filter paper, absorbent cottonwool or cotton etc., as was previously explained, and in 408 the next solution in the series is loaded into the capillary space by immersing the distal end therein. After the last solution is drained in 406 the capillary duct can be inserted in 410 into, e.g., liquid nitrogen, liquid nitrogen slush or liquid air for cryopreservation.

Therefore, embodiments of the invention disclose a device (such as device 100) that is configured to treat the biological sample with a series of solutions. The series may comprise any applicable number (n) of solutions, such that n=1, n=2, n=3, n=4, n=5, 5=6, n=7, n=8, n=9, n=10, or any other applicable number of solutions as appropriate to the case.

In addition, it should be understood that the flowchart of FIG. 4 is disclosed by way of example only, and other embodiments may exist. For example, device 100 of FIG. 1, with any applicable pod (see, e.g., FIGS. 2A to 2F) is configured to be used for preparation of a biological sample for cryopreservation as well as for cryopreservation itself, as it can be inserted into liquid nitrogen. However, alternative methods to those presented with reference to FIG. 4 may skip 410 (“insert into liquid nitrogen”). Instead of cryopreserving the sample while inside the device, it is possible to extract it from the capillary space, transfer it to another container or tool for insertion into liquid nitrogen.

Further to understanding the embodiments described so far, it can be appreciated that solutions can be loaded into the capillary space by additional or alternative ways to capillarity action. For example, according to some embodiments it is possible to connect a pump to the proximal end of the capillary duct, thus pumping the solution into the capillary duct instead of letting it flow in by capillary action alone. Moreover, understanding that the solution (or generally, the liquid) flows into the capillary duct by the force affected by the pump, it can be appreciated that in some embodiments the capillary duct must not be capillary anymore. That is, embodiments of the invention comprise a “straw”, or a “tube”, wherein a “capillary duct” is a private case of a straw. Similarly, a “straw space” is the space inside the straw, while “capillary space” is a private case of a straw space that exhibits capillarity.

It is noted that all the embodiments previously presented with reference to devices comprising a capillary duct apply also to devices comprising a straw. This includes also the embodiments of the pods. Accordingly, the embodiments presented with reference to FIGS. 1, 2A to 2F and 3A to 3C should apply also to a non-capillary straw, mutatis mutandis.

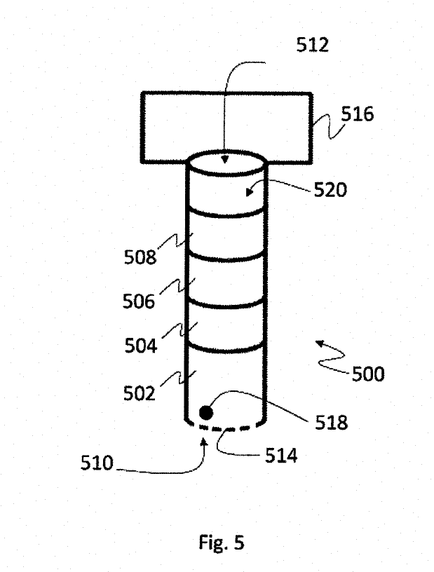

When a pump is coupled to a straw in order to draw liquid into the straw space, according to embodiments alternative to the method of FIG. 4, it may not be required to drain the liquid from the straw space prior to loading the next liquid thereto. In those cases that the second liquid (for example, equilibration solutions) has a density that is higher than the density of the first liquid (for example, holding medium), the third (such as vitrification solution) has higher density compared to the second and so forth (in a series of solutions wherein the solutions are ordered in an ascending order of densities, i.e., wherein each solution, apart of the first, has higher density compared to the density of its preceding solution in the series, in other words, it is heavier), it may be understood that having a layer of a solution above a layer of previous solution in the straw space would not result in mixing thereof, at least not without investment of additional energy, such as by mixing. FIG. 5 illustrates a straw 500 having four different layers therein, marked as 502, 504, 506 and 508. The straw distal end is marked 510 and the proximal end is 512. In the distal end there is a perforated member 514 that can be, for example, the perforated member of any one of the pods describes with reference to FIGS. 2A to 2F. Straw 500 can be capillary or not, as applicable to the case. It can be appreciated that layer 502 is of the heaviest solution (in terms of density), 504 is lighter, 506 is even lighter, and the lightest is 508. 516 represents a pump, coupled to the straw at its proximal end 512. 518 represents a biological sample and 520 represents the straw space.

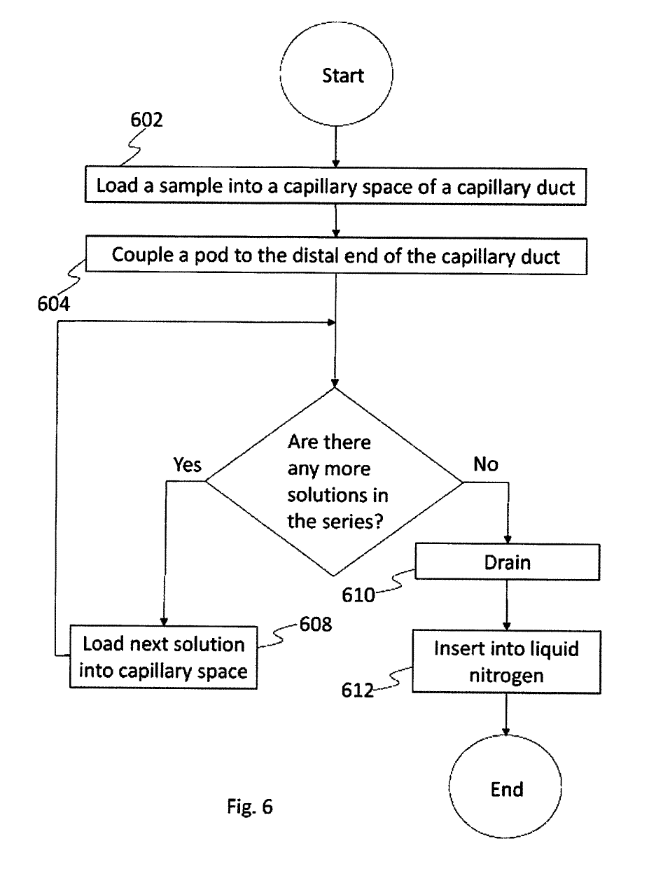

FIG. 6 is a flowchart illustrating procedures taken in order to prepare a sample for vitrification, according to embodiments of the invention. Basically, FIG. 6 resembles FIG. 4, though no draining is performed among the loadings of the different solutions. In 602 a sample (such as 102 or 518) is loaded to a straw space (e.g., 114 or 520) of an empty straw (e.g. 108 or 500). As was previously explained, loading can be done, for example, by capillary action in a capillary duct or by using a pump (such as 112 or 516). It should be noted that immediately further to loading, the sample resides inside the straw space, submerged in a liquid that is similar to the liquid in which it was submerged prior to loading. Hence, for example, had the sample been stored in a holding medium prior to loading, then immediately after loading there would be a sample submerged in the holding medium inside the straw.

In 604 a pod is coupled to the distal end of the capillary duct. Coupling is performed by any way applicable to the case, such as by applying pressure (see FIGS. 3A to 3C), by screwing etc. The perforated member of the pod would prevent the sample from unintentional running out of the capillary space via the distal end of the capillary duct.

It has been noted before that those versed in the art of vitrification would appreciate that in order to prepare a biological sample for vitrification the sample needs to be submerged in a series of solutions while the densities of the solutions increase as the preparation advances, because the concentration of cryoprotectants increases. Accordingly, for each solution in the series, in 608 the next solution in the series is loaded into the capillary space by immersing the distal end therein and operating the pump. Finally, all the layers are drained in 610 and the straw can be inserted in 612 into liquid nitrogen for cryopreservation.

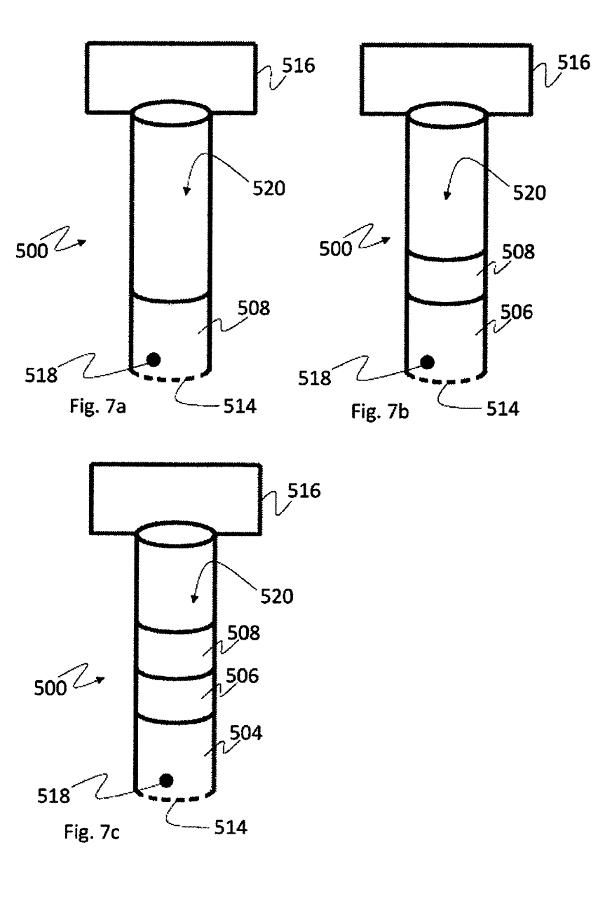

FIGS. 7A, 7B and 7C illustrate stages of loading the straw of FIG. 5, according to embodiments of the invention. The same stages may occur with the capillary duct of FIG. 1 when it has a pump coupled thereto. In FIG. 7A the first layer 508 is loaded with the biological sample 518. In the described example, of preparing the sample for vitrification, the first layer may be of a holding medium. Then, in FIG. 7B, a second layer 506 is loaded as well. Layer 506 in the example is of a holding solution whose density is higher than the holding medium and hence layer 508 is “pushed up” thereby and layer 506 appears below. It is advised to avoid shaking the straw, or the layers may mix. In addition, the biological sample gradually absorbs the holding solution, which replaces the holding medium that has been there before. This turns the sample heavier and therefore it sinks from layer 508 to layer 506. Thereafter, because there are other unloaded solutions in the series, the process repeats itself and layer 504 is loaded, as illustrated by FIG. 7C. Layer 504 may be of equilibrium solution. It is heavier than the holding solution of layer 506, and therefore layers 506 and 508 are pushed up, layer 504 resides therebelow, and sample 518, which absorbs the equilibrium solution, further sinks to layer 504. Finally, a fourth solution (such as a vitrification solution) in the present example is loaded to yield FIG. 5, wherein layer 502 comprises the fourth, heaviest solution and biological sample 518 sinks again. The fourth solution may be another equilibrium solution, heavier than that of layer 504.

It is noted that the description above does not intend to teach how to perform vitrification. Rather it is intended at teaching how to use the straw in order to prepare the sample for vitrification. Therefore, the procedure described does not intend to be an accurate vitrification procedure. Further to reading the procedure described herein, a person versed in the art of vitrification will be able to apply the procedure to a known per se vitrification process.

Further to understanding the embodiments presented so far, additional embodiments are presented, which require neither capillarity nor the usage of a pump. The concept of communicating vessels is a known concept since ancient times. When a tube, open at both ends, is immersed in a container with a liquid, the liquid would fill the tube to a level similar to the level of the liquid in the container.

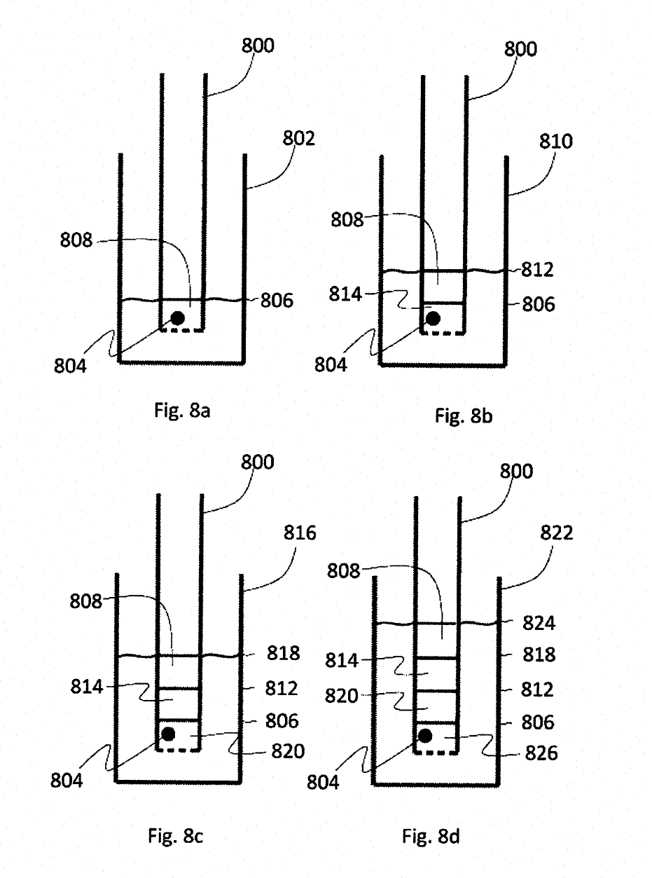

FIG. 8 illustrates loading four solutions into a straw, according to embodiments of the invention. In FIG. 8A a straw 800 is immersed in a first solution within a container 802 in order to load a biological sample 804. Straw 800 is coupled to a perforated member in its distal end. The level of the solution in container 802 is marked by 806. If the procedure is, e.g., preparation of a biological sample for vitrification, the first solution may be a holding medium in which the biological sample resides. In order to load the sample into the straw, a pump can be coupled to the proximal end thereof, and possibly disconnected after the loading. The pump, which is not illustrated in FIG. 8 though it can be seen, for example, in FIG. 1 (see 112), can be, e.g., an electrical pump or a manual pump such as a bulb.

As can be seen in the figure, inside straw 800 there is obtained a layer 808 of the first solution, whose level is similar to the level of the solution in the container. Thereafter, the straw can be transferred to a second container 810, holding a second solution, heavier than the first solution, whose level in the container, marked as 812, is higher than level 806 of the first solution in container 802. In response, the lighter layer 808 would be pushed up so as to equalize level with the liquid level 812, wherein a new layer 814, of the second solution, would reside therebelow. In addition, it is illustrated in the figure that biological sample 814 would sink from layer 808 to layer 814, as was previously explained with reference to FIGS. 7A, 7B and 7C. Therefore, biological sample 814 is being treated by the second solution in the straw space.

It is noted that upon transferring straw 800 from container 802 to container 810, layer 808 of the first solution should be kept inside. If the straw is narrow enough to maintain capillarity, the layer will be kept inside. However, if the straw does not maintain capillarity, it may be required to seal its proximal end during the transfer, thus preventing loss of layer 808. This is relevant to any transfer of the straw between one container to another.

Further on, straw 800 is transferred to container 816, holding an even heavier third solution, whose level 818 is higher than level 812 of the second solution in container 810. Again, the two previous layers (808 and 814) are pushed up by the third solution to equalize the level inside the straw to level 818 of the third solution. Thus, layer 820 of the third solution is created below layers 808 and 814, while sample 804 sinks thereto. Therefore, biological sample 814 is being treated by the third solution in the straw space.

Finally in the present example, straw 800 is transferred to container 822, holding a fourth, heaviest solution, whose level in the container, marked as 824, is higher than level 818 of the third solution in container 816. In response, layers 808, 814 and 820 are pushed up by the fourth solution to equalize the level inside straw 800 to level 824 of the fourth solution. Thus, layer 826 of the fourth solution is created below layers 808, 814 and 820, while sample 804 further sinks thereto. Therefore, biological sample 814 is being treated by the fourth solution in the straw space.

At this stage the reader should understand that the invention is not limited to four layers of four solutions. The number of layers and solutions may vary as required, and it can be one layer and solution, two layers and solutions, three layers and solutions, four layers and solutions, five layers and solutions, six layers and solutions, seven layers and solutions, eight layers and solutions, nine layers and solutions, ten layers and solutions, or any other number of layers and solutions applicable to the case. Generally, the device is configured to treat the biological sample with a series of solutions whose density increases gradually.

In addition, in the figure, containers 802, 810, 816 and 822 are resembling. However, this is non-mandatory as well. Due to the communicating vessels concept, the level of liquid in the straw would become the same as the level of liquid in the container where it is immersed, regardless of the shape and volume of the containers.

Moreover, while in the example the level of the solution in the containers gets higher as the process advances, it should be understood that this is non-mandatory as well. Instead, it is possible to keep the level constant or even lower it, as long as the straw is immersed deeper and deeper in the solution. Hence, generally speaking, any manipulation allowing rise of the level of solution in the straw space in accordance with the communicating vessels concept may be applied, including combinations (e.g., for the second layer increase the volume, for the third layer immerse deeper, etc., as applicable to the case).

Further to understanding how the communicating vessels concept can be applied by some embodiments of the invention, other embodiments are presented. In these embodiments it is possible to fill the straw space with a layer of solution, then closing the proximal end of the straw space. Next, if the straw is transferred to another solution (or if the solution in the container changes to another solution), it should be appreciated that the composition of the solution in the layer, or at least in its bottom, near the distal end, will gradually change by diffusion.

While embodiments presented so far referred to gradually increasing densities, it should be appreciated that this is not always the case and sometimes the densities may be gradually decreased instead of increased. One such example is while warming or thawing a vitrified biological sample. In such an example, there is a need to gradually reduce the concentration of cryoprotectants around and within the sample. In some embodiments, a high concentration of sucrose (e.g., a 1M, 1 Molar sucrose solution) is used to dilute the vitrification solution in the straw space, thereby diluting the vitrification solution. Thereafter the solution is further diluted by a lower concentration sucrose solution, such as 0.5M and so on.

Understanding that sometimes the densities may be decreased rather than increased, it is generally said herein that and further to reviewing the different embodiments of the invention, those involving change of solution (see, e.g., FIG. 4), those involving diffusion of solutions, and those involving layers of solutions (see, e.g., FIGS. 5, 6, 7A-7C and 8), it is generally explained that the biological sample loaded into the straw space is gradually exposed to solutions having gradually changing densities. The perforated element prevents loss of the sample, while it still allows in-flow and out-flow of the solutions therethrough (solutions are kind of liquids).

Further to being acquainted with the embodiments of devices configured to perform a cryoprocedure, it should be realized that common practice in the field of vitrification and generally cryopreservation, is to manually transfer the sample from one solution to another and then directly plunge the sample into liquid nitrogen. Indeed, the devices described above (the straws) are configured to be transferred from one solution in the series to another in a manual manner, i.e., by a human technician. This practice is cumbersome and requires high laboratory skills from the lab technicians. In addition, the plunging of the sample in liquid nitrogen or in liquid nitrogen slush must be quick and precise. Therefore, it is desired to have an automatic device that can handle the vitrification of the sample in an automatic way. Moreover, when the sample undergoes vitrification stages in vitrification trays prior to insertion thereof into a straw, the operator risks losing the sample in the relatively large volume. Indeed, SUN and LIU (US 2016/0029619), for example, required a complicated and expensive image processing system in order to make sure that the sample is not lost.

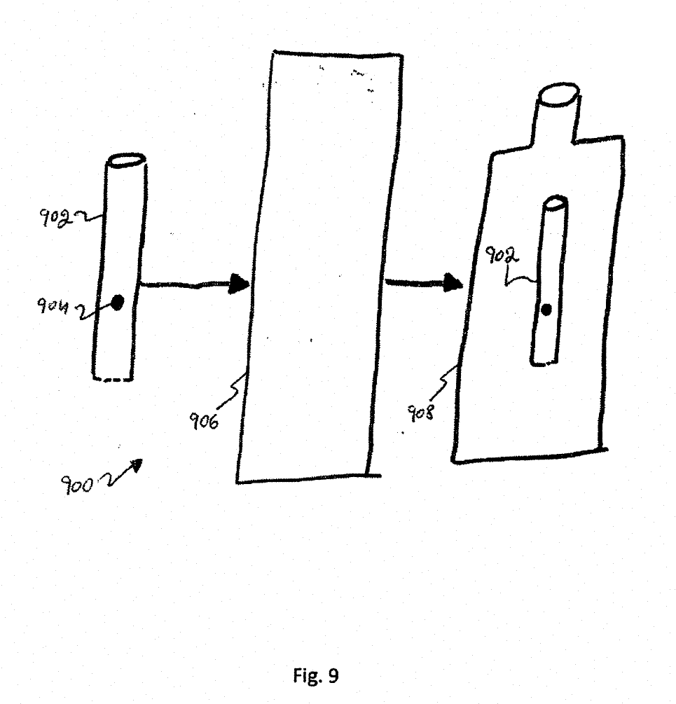

Unlike, e.g., US 2016/0029619, where vitrification is performed in a vitrification tray, according to embodiments of the invention one or more biological samples are inserted or loaded into the straw (whether a capillary duct or a non-capillary straw) in advance. It may be inserted thereto in a manual manner by a human technician, or, if applicable, by an automatic device if such a device is available. Then, embodiments of the invention provide automatic devices configured to perform a cryoprocedure on the one or more biological samples carried by the straw. If the cryoprocedure is vitrification, then the system may be schematically represented by system 900 of FIG. 9, wherein a straw 902, that carries a biological sample 904 is conveyed to device 906 configured to automatically perform vitrification (which is one type of a cryoprocedure). Device 906 receives straw 902, holds it and automatically performs vitrification of sample 904, as will be described in detail below. Then, straw 902 is further conveyed to a container 908 of, e.g., liquid nitrogen for cryopreservation.

It should be appreciated that in FIG. 9 a single sample 904 is illustrated though this is non-limiting and any other number of samples can be loaded, if applicable to the case, i.e., straw 902 can carry one or more samples 904.

Further to understanding that device 906 performs vitrification and to understanding, with reference to FIGS. 1-8 how a straw can be used to vitrify a biological sample, it should be appreciated that the distal end of the straw, coupled to the perforated element, should be submerged in proper solutions. In some embodiments, based on capillarity, it is enough to touch each of the solutions with the straw's distal end, while in other embodiments, such as those illustrated in FIGS. 8A-8D, the straw needs to be submerged into variable depths of the solutions. Accordingly, the part of the straw that needs to touch the solution, or to be submerged therein, is considered an “active portion of the straw”, while it has been shown that the active portion of the straw may change in accordance with the embodiment.

Moreover, while the solutions are held in containers, such as containers 802, 810, 816 and 822 in FIGS. 8A to 8D, and the sample, or samples, are carried within a straw, it should be realized that in order to submerge the active portion of the straw in a solution held by a container, the active portion of the straw should be brought in contact with the solution, and for that to happen, there must be relative motion of the straw and the container with respect to each other. Accordingly, in some embodiments the straw should be mobile while the container is stationary; in other embodiments, the straw may be stationary while the container is mobile; and in still other embodiments, both the straw and the container may be mobile.

Mobility of either the straw and/or the container can be achieved by coupling the straw and/or container to a respective holder and driver. A holder configured to hold one or more straws is referred to, herein, as a “straw holder” while a holder configured to hold one or more containers is referred to as a “container holder”. Similarly, a driver configured to move one or more straws is referred to, herein, as a “straw driver” while a driver configured to move one or more containers is referred to as a “container driver”. Having said that, it can be realized that a device configured to automatically perform vitrification, such as device 906 in FIG. 9, should comprise at least one straw holder and at least one straw driver, and/or it should comprise at least one container holder and at least one container driver.

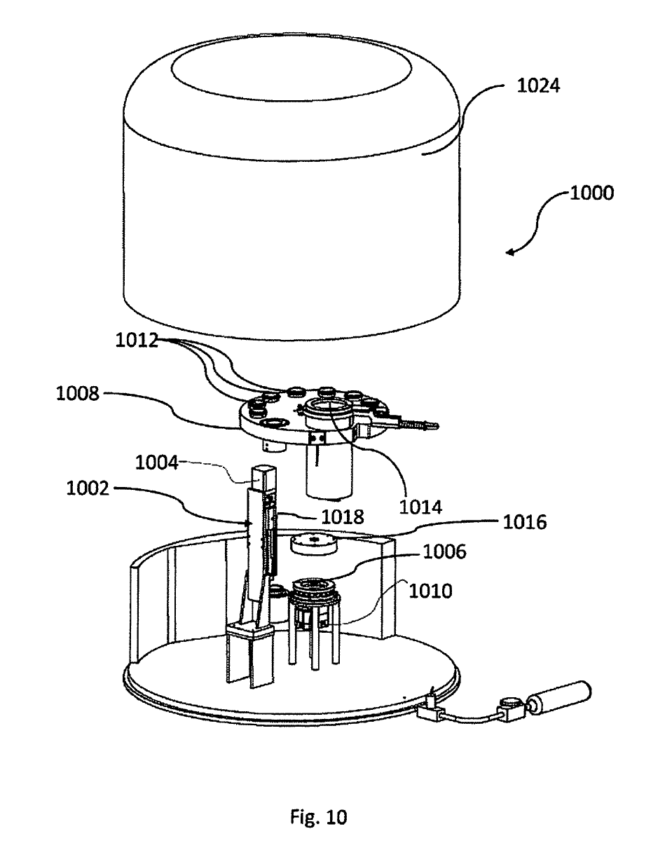

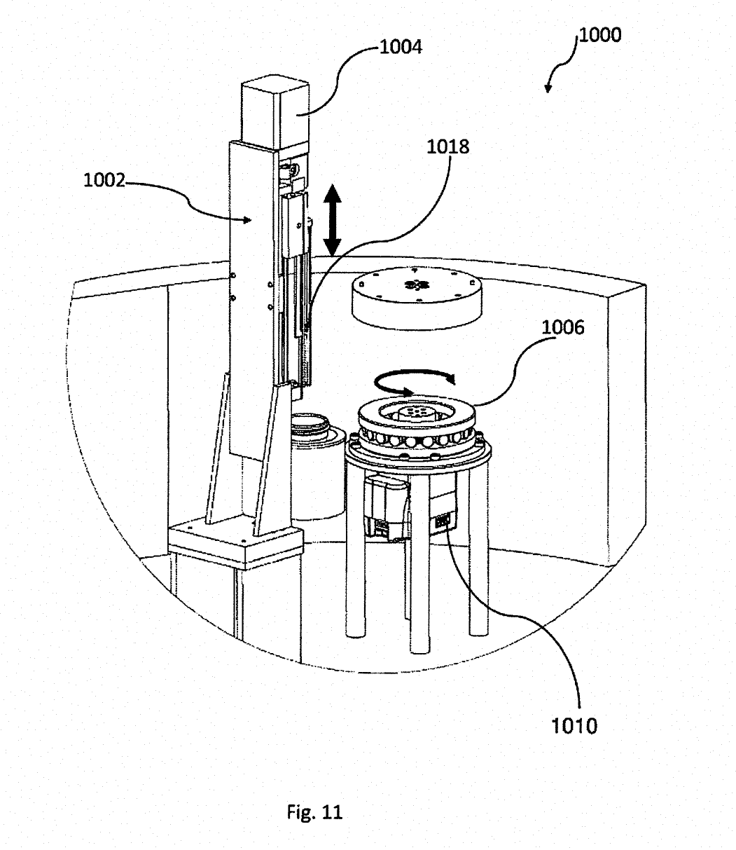

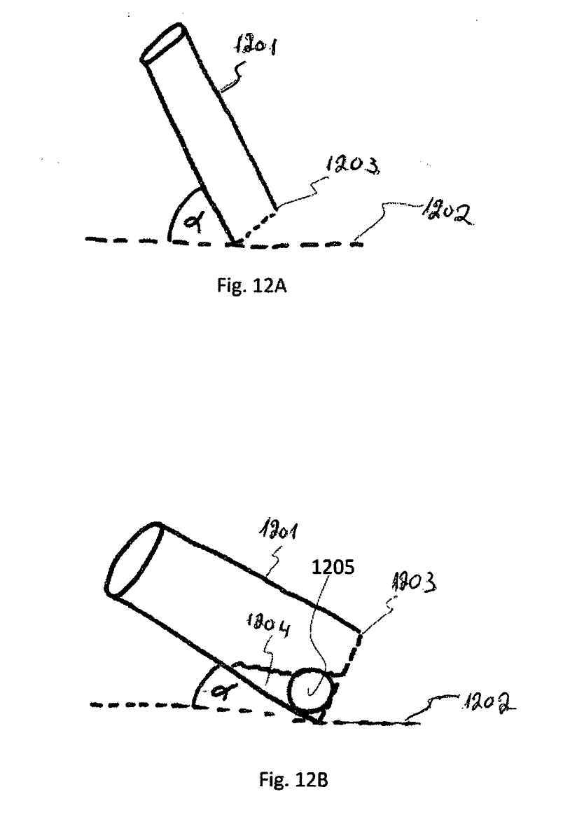

FIG. 10 presents a device 1000 for automatic vitrification of one or more biological samples, according to embodiments of the invention, while FIG. 11 presents in details the elements of the device enabling relative motion. Device 1000 can be used, e.g., instead of device 906 in system 900 of FIG. 9. Device 1000 comprises a straw holder 1002 and a straw driver 1004. It also comprises a container holder 1008, which, in this case, is a plate (hence referred to as a “container plate”), and a container driver 1010.

Container plate 1008 is configured to hold two or more containers 1012, such as vials, in predetermined locations on the plate. In addition, the container plate is also configured to hold a liquid nitrogen (LN) container 1014, while it should be realized that the two or more containers are not limited to solution containers (vials) alone. Container driver 1010 is configured to translate the container plate, so as to position it in a place accessible to the straw holder. In this case container driver 1010 is a rotational driver, being able to rotate the plate. The container driver can, in some embodiments, be controlled by a computer.

In order to relay motion to the container plate, device 1000 comprises a thrust bearing element 1006 and a bearing-plate connector 1016. The thrust bearing element allows a smooth rotation of the plate while minimizing friction, thus preventing movement of the solutions in the containers while the plate rotates.

The straw holder is configured to receive at least one straw, and hold it in an upright position. An upright position may be a vertical position wherein the distal end of the straw faces downwards. An upright position may also be a diagonal position, as illustrated in FIG. 12A, wherein a is the acute angle between the straw 1201 and the horizontal plane 1202. In a diagonal position, the distal end of the straw 1203 should also face downwards. If the angle a is acute, a person versed in the art would realize that the solution in the straw 1204 may not cover the biological sample 1205, as illustrated in FIG. 12B. Therefore, an upright position allows holding the straw in a diagonal position, as long as the sample is completely submerged in the solution within the straw space. Furthermore, it should be realized that in some embodiments the carrier should be submerged in a certain minimal or maximal depth in a solution, e.g., as with reference to FIGS. 8A-8D. In these cases it may be the vertical depth that matters. Hence, when a certain length of a straw is submerged in a diagonal position, it should be realized that the vertical depth of submersion is actually less than the submerged length of the straw. It should be realized to submerge an active portion of each one or more carriers held by the carrier holder in a predetermined vertical depth in the position accessible to the carrier holder.

Returning to FIGS. 10 and 11, the straw holder, alternatively referred to also as a linear actuator, 1002, is coupled to a straw driver (motor) 1004. The straw holder may hold more than one straw at a time. When a container is positioned in a predetermined position below the straws 1018 held by straw holder 1004, straw driver 1004, according to the present embodiments, lowers and highers the one or more straws 1018 vertically, in a way inserting them into the containers and extracting them therefrom.

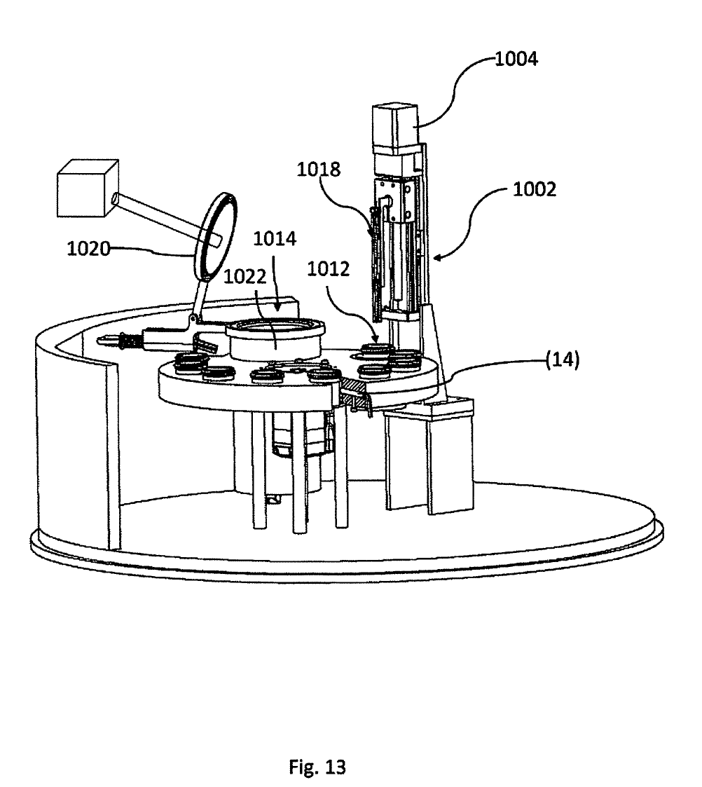

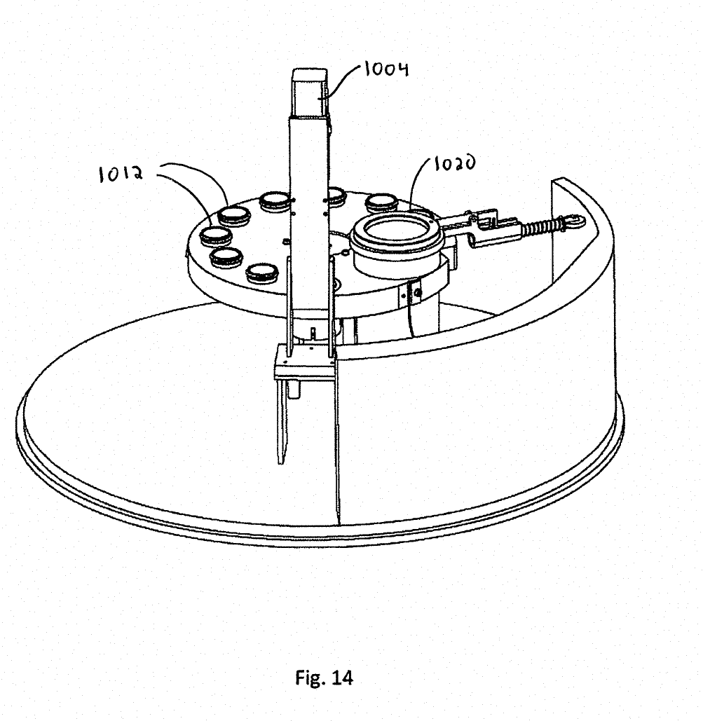

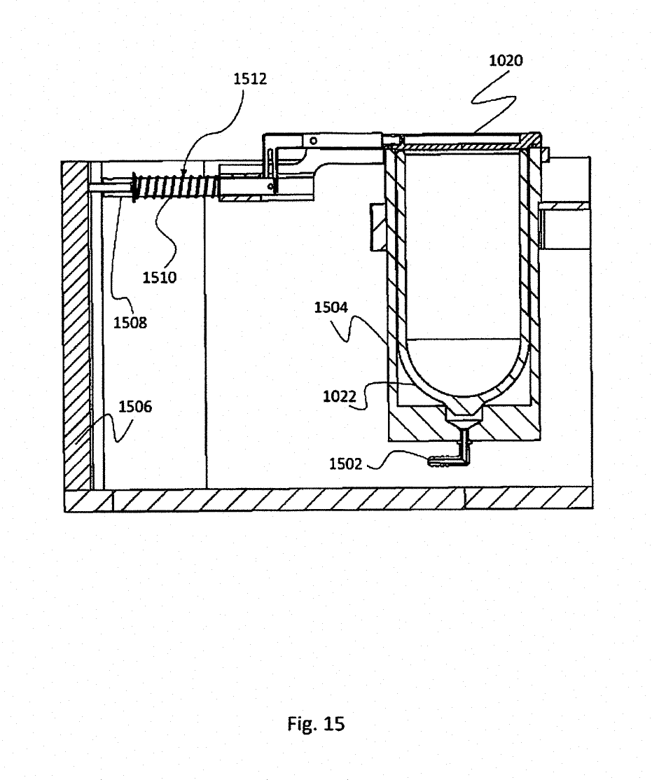

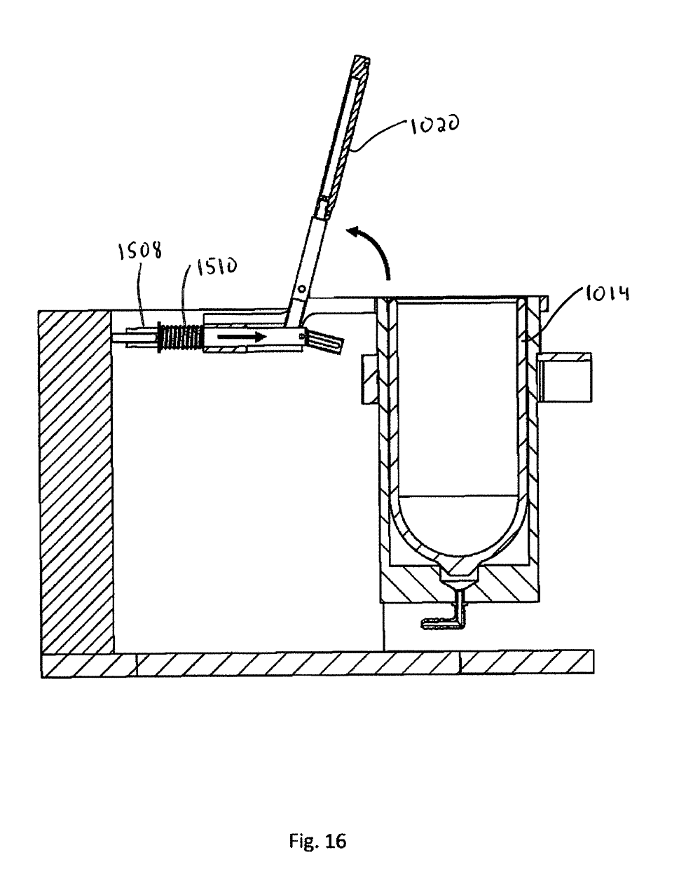

FIG. 13 illustrates operation of device 1000, according to some embodiments of the invention. One or more straws 1018 can be seen half way towards a container 1012. Also seen in FIG. 13 is LN container 1014 in an open position. FIG. 14 illustrates device 1000 with a closed LN container, according to some embodiments of the invention. The LN container comprises a lid 1020 and an LN Dewar 1022. According to some embodiments, the lid opens automatically when the LN container reaches the position under the one or more straws 1018. The automatic opening can be mechanical, as illustrated in FIGS. 15 and 16.

FIG. 15 illustrates a liquid nitrogen container, such as LN container 1014, with a closed lid 1020, according to embodiments of the invention. FIG. 16 illustrates a liquid nitrogen container, such as LN container 1014, with an open lid 1020, according to embodiments of the invention. A tube 1402 is coupled to lid 1020 or to an isolated chamber 1504, and to a vacuum pump, which reduces the pressure of the LN and decreases the liquid nitrogen temperatures. A heater and a temperature controller are set inside the containers plate (i.e., the container holder), that may be made of metal, thus controlling the temperatures of the solutions in the containers. The lid can be closed and opened by a cam/follower mechanism. A following wheel is rotating on the device wall 1506. In certain places where the wall is thicker, a collapsing plunger 1508, which is held by a spring 1510, will push a rod 1512 and will open lid 1020.

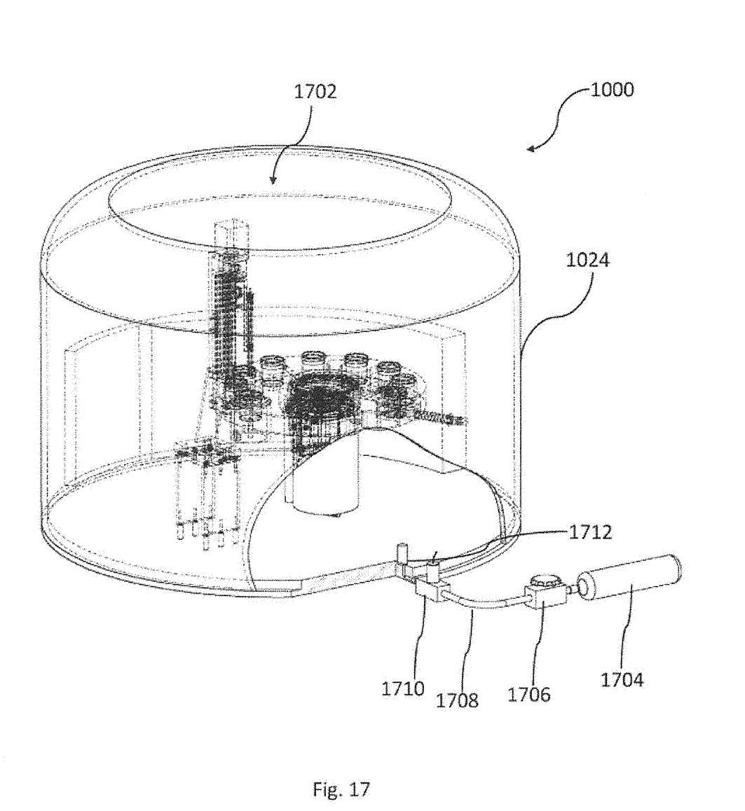

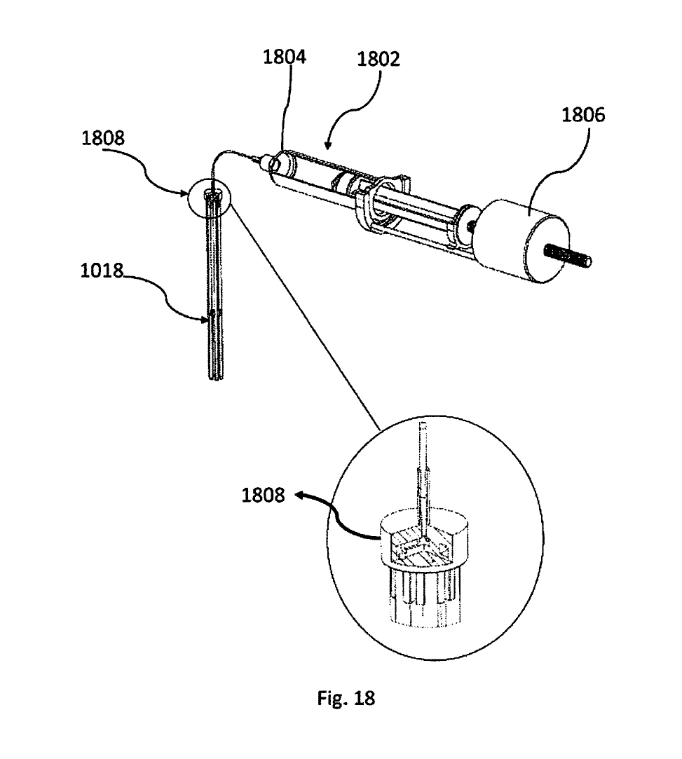

Reverting the FIG. 10, the figure shows a cover dome 1024. The cover dome if further explained now, with reference to FIG. 17, illustrating a device 1000 for automatic vitrification of one or more biological samples, according to embodiments of the invention. Cover dome 1024 is utilized to generate an internal environment 1702, whose gas composition and level is controlled. For example, gasses that are controlled are CO₂ and Oxigen, while their levels may be maintained at 5% oxygen, 5% CO₂, and 90% Nitrogen. A gas container 1704 is connected to a pressure regulator 1706 by a gas tube 1708 and to an electric valve 1710. A gas sensor 1712 is measuring the gas level inside the dome and controls the gas flow through tube 1708.

FIG. 18 demonstrates a syringe pump 1802 coupled to the one or more straws 1018, illustrated in FIGS. 10, 11 and 13, according to embodiments of the invention. Syringe pump 1802 comprises a syringe 1804 and a driver (also may be named a “motor”) 1806 which push or pull the syringe toward the one or more straws in order to fill or evacuate solution therefrom. The one or more straws are coupled to a distributor 1808 which distributes the liquid equally between the one or more straws 1018.

It should now be realized that a straw is a private case of a carrier. Therefore, the invention is not limited to using straws as carriers and other kinds of carriers can be used, e.g., with device 1000 and other embodiments of the invention, if applicable to the case. For example, according to embodiments of the invention a biological sample can be glued to a surface, wherein the surface is a carrier. The surface with the sample can be conveyed to the carrier holder (such as 1002) in order for device 1000 to perform an automatic cryoprocedure on the sample. Gluing in these embodiments maintains the sample on the carrier (surface, in this case) and prevents it from separating therefrom when the carrier is, e.g., in the upright position.

Accordingly, the embodiments described with reference to FIGS. 9-17 may all be applicable to, generally, “one or more carriers” and not only “one or more straws”. In these cases, therefore, “straw holder” can be replaced by “carrier holder” and the “straw driver” can be replaced by “carrier driver”.

In addition, further to understanding how the automatic devices can be used for vitrification, it should be realized that they can be used also for other cryoprocedures, including thawing and warming, wherein the samples should be submerged in warming solutions in the containers.

Although various embodiments of the invention have been described above, these are only given for the purpose of explanation of the present invention and the range of the present invention should not be considered as being limited only to these embodiments.

What is claimed is:

1. An automatic device for performing a cryoprocedure on at least one biological sample carried by one or more carriers, the device comprising:
a carrier holder configured to receive and hold the one or more carriers while carrying the at least one biological sample;
a container holder configured to hold two or more containers each in a predetermined location on the container holder; and
a container driver coupled to the container holder, the container driver is configured to translate the predetermined locations so as to position one of the containers in a position accessible to the carrier holder so as to submerge an active portion of the carrier to a predetermined depth in the container.

2. The automatic device of claim 1, wherein each of the one or more carriers is a straw.

3. The automatic device of claim 2, wherein the straw holds the at least one biological sample by capillary action.

4. The automatic device of any one of claim 1, wherein the one or more carriers is held in an upright orientation by the carrier holder.

5. The automatic device of claim 1, further comprising a carrier driver to change a position of the carrier holder to thereby change a position of the carrier held by the carrier holder.

6. The automatic device of claim 1, wherein the container driver is a rotational driver to change the position of the containers with respect to the one or more carriers.

7. The automatic device of claim 6, wherein the carrier driver comprises a motor, and the carrier holder is movable linearly by the motor to submerge the active portion of the carrier in the container.

8. The automatic device of claim 1, wherein the container holder supports a liquid nitrogen container for receipt of the carrier.

9. An automatic device configured to perform a cryoprocedure on at least one biological sample carried by a carrier, the device comprising:
a carrier holder configured to hold the carrier containing at least one biological sample;
a carrier driver operably connected to the carrier holder to move the carrier holder from a first position to a second position; and
a container holder configured to hold a first container and a second container;
wherein the carrier holder moves from the first position wherein the at least one biological sample contained in the carrier is out of contact with a liquid in the first container to a second position wherein the at least one biological sample contained in the carrier is in contact with the liquid in the first container.

10. The automatic device of claim 9, further comprising a container driver operably connected to the container holder to change a position of the first container for alignment with the at least one carrier.

11. The automatic device of claim 9, wherein the carrier is a straw.

12. The automatic device of claim 10, wherein the carrier holder moves linearly between the first and second positions.

13. The automatic device of claim 10, wherein the container driver causes rotational movement to rotate the first container with respect to the carrier holder.

14. The automatic device of claim 9 wherein the carrier holder is configured to hold the carrier in an upright position.

15. The automatic device of claim 9, wherein the second container contains a liquid of a different density that a liquid in the first container.

16. The automatic device of claim 9, wherein the second container contains liquid nitrogen, and the carrier is submergable in the liquid nitrogen by movement of the carrier holder.

17. An automated method to perform a cryoprocedure on at least one biological sample, the method comprising the steps of:
a) submerging the at least one biological sample contained in a carrier into a first container;
b) removing the at least one biological sample from the first container;
c) aligning the carrier containing the at least one biological sample with a second container; and
d) submerging the at least one biological sample contained in the carrier into a second container.
wherein steps a-d are performed by an automated device.

18. The method of claim 17, wherein the step of submerging the at least one biological sample contained in the carrier into a first container includes the step of changing the vertical position of the carrier by movement in a first direction.

19. The method of claim 18, wherein the step of removing the at least one biological sample from the first container includes the step of changing the vertical position of the carrier by movement in a second direction.

20. The method of claim 17, wherein the first and second containers are supported on a container holder, and the container holder is rotatable to align the second container with the carrier after step (b).
